(19) United States
(12) Patent Application Publication
(10) Pub. No.: US 2013/0164407 A1
(43) Pub. Date: Jun. 27, 2013

(54) HEALTH BREAD BASED ON NON-GRAIN FLOUR

(71) Applicant: Nathan Kaufman, Brooklyn, NY (US)

(72) Inventor: Nathan Kaufman, Brooklyn, NY (US)

(21) Appl. No.: 13/337,321

(22) Filed: Dec. 27, 2011

(51) Int. Cl. A21D 13/00; A21D 2/00; A21D 13/04

(52) U.S. Cl. 426/18; 426/549; 426/550

(57) ABSTRACT

An intermediary baking product, such as a dough, which consists of a primary non-grain flour portion and a secondary grain flour portion wherein the non-grain flour portion is at least double the percentage of the grain flour portion. The intermediary baking product having a regular bread-dough-like form.

### FIELD AND BACKGROUND OF THE INVENTION

The present invention relates to a health bread and, more particularly, to health bread product and methods for preparing the same.

Various seeds and legumes are well known to have excellent nutritional value. Nutritionists and dieticians regularly advise patients to include various seeds and legumes in the diet so as to improve general well-being and advise including specific ingredients to improve specific ailments. Sufferers of high cholesterol are often advised to include flaxseed in the diet. Flaxseed oil is one popular method of including flaxseed in a diet, although many patients complain that the oil is not to their liking and difficult to ingest at the necessary volume on a daily basis. Many recipes have recently become available including flaxseed in cooked and baked preparations. The cooked or baked flaxseed alternative is often more appealing than the aforementioned alternative of direct consumption of the flaxseed oil. Unfortunately, many of those who suffer from ailments that require a flaxseed component in the diet also suffer from ailments which preclude the consumption of the better tasting preparation, and in particular, the baked foods.

In particular, but certainly not exclusively, diabetic patients are advised and sometimes even prohibited from eating bread and other baked goods which have a high sugar content. Moreover, overweight individuals (even those who are not diabetic) are advised to consume a low sugar, low carbohydrate diet. On average, breads have a carbohydrate count of 40-50 g per 100 g and cakes and crackers can be as high as 70-90 g per 100 g.

Flaxseed

Flax is a plant. The seeds in the flax plant are filled with flaxseed oil, (also called linseed oil). The seeds contain fatty oils called alpha-linolenic acid (ALA) and linoleic acid. ALA is the omega-3 oil in flaxseed. Flaxseed contains both omega-3 fatty acids and omega-6 fatty acids. Flaxseed oil consists of approximately 55% ALA, which makes it six times richer in omega-3 fatty acids than most fish oils. The husks of the seeds are rich in mucilage. Both the seed oil and mucilage have many nutritional and therapeutic properties.

Flax seeds may lower cholesterol levels, especially in women. Flax also contains other important substances like lignans, which may protect against some types of cancer. Initial studies suggest that flax seeds taken in the diet may benefit individuals with certain types of breast and prostate cancers. A study, done at Duke university, suggests that flaxseed may stunt the growth of prostate tumors, although a meta-analysis found the evidence on this point to be inconclusive. Flax may also lessen the severity of diabetes by stabilizing blood-sugar levels.

Numerous additional health and nutritional qualities have been attributed to flax seed and flaxseed oil, some of which have been substantiated or partially substantiated through research.

Almonds

Almonds contain approximately 49% oils, of which 62% is monounsaturated oleic acid (an omega-9 fatty acid), 24% is linoleic acid (a polyunsaturated omega-6 essential fatty acid), and 6% is palmitic acid (a saturated fatty acid). The sweet almond contains about 26% carbohydrates (12% dietary fiber, 6.3% sugars, 0.7% starch and the rest miscellaneous carbohydrates), and may therefore be made into flour for cakes and cookies for low-carbohydrate diets. A standard serving of almond flour, 1 cup, contains 20 grams of carbohydrates, of which 10 g is dietary fiber, for a net of 10 g of carbohydrate per cup. This makes almond flour very desirable for use in cake and bread recipes by people on carbohydrate-restricted diets. To date, Almond flour has only been successfully incorporated into bread as an additive, where the amount of almond flour per net weight is smaller than that of the main grain flour ingredient.

Almonds are a rich source of vitamin E, containing 26 mg per 100 g and are also rich in dietary fiber, B vitamins, essential minerals and monounsaturated fat (one of the two “good” fats which potentially may lower LDL cholesterol). Typical of nuts and seeds, almonds also contain phytosterols, associated with cholesterol-lowering properties.

Potential health benefits, which have not been scientifically validated, include improved complexion and possibly a lower risk of cancer. Preliminary research associates consumption of almonds with elevating blood levels of high density lipoproteins and lowering low density lipoproteins. A preliminary trial showed that, in spite of the high fat content of almonds, using almonds in the daily diet might lower several factors associated with heart disease, including cholesterol and blood lipids.

Soy

Together, oil and protein content account for about 60% of dry soybeans by weight; protein at 40% and oil at 20%. The remainder consists of 35% carbohydrate and about 5% ash. Soybeans are considered by many agencies (including the Food and Drug Administration) to be a source of complete protein. A complete protein is one that contains significant amounts of all the essential amino acids that must be provided to the human body because of the body's inability to synthesize them. Consumption of soy may also reduce the risk of colon cancer, possibly due to the presence of sphingolipids.

It would be highly advantageous to have a product and method for preparing nutritional bread and other baked products based primarily on non-grains such as flaxseed or almonds or soybeans where the product has a form and texture substantially similar to the same product based on wheat flour. It would be further advantageous if the aforementioned baked goods have a substantially lower carbohydrate count than the same produced from grain flour.

### SUMMARY OF THE INVENTION

According to the present invention there is provided an intermediary baked goods product including: (a) a portion of grain flour; (b) a portion of non-grain flour, wherein said non-grain flour portion is at least double said portion of grain flour by net weight; and (c) a binding agent, where the intermediary baked goods product, such as a dough, has a consistency of a homogeneous bread-dough-like substance rather than the consistency of a batter.

According to further features in preferred embodiments of the invention the non-grain flour is a flaxseed flour or a soybean flour or an almond flour.

According to still further features in the described preferred embodiments the portion of grain flour has a range of between 4%-8% of the product by net weight and the portion of non-grain flour has a range of between 8%-35% of the product by net weight. Alternatively, the portion of grain flour has a range of between 8%-12% of the product by net weight and the portion of non-grain flour has a range of between 16%-35% of the product by net weight. Further alternatively the portion of grain flour has a range of between 10%-18% of the product by net weight and the portion of non-grain flour has a range of between 20%-36% of the product by net weight

According to still further features there is provided a final baked goods product baked from the intermediary baked goods product such as bread, pita bread, bagel, baguette, pizza base, flat bread, pasta and noodles.

According to still further features the bread has a crust portion and a crumb portion.

According to still further features the binding agent is gluten.

According to still further features the binding agent is prebaked.

According to still further features the intermediary product is sugar free and includes only natural ingredients.

According to the present invention there is provided a method for preparing an intermediary baked goods product, the method including the steps of: (a) prebaking a portion of non-grain flour; (b) preparing a fermentation starter; (c) preparing a mixture of dry ingredients including a portion of grain flour and a binding agent, wherein the non-grain flour portion is at least double the portion of grain flour by net weight; and (d) mixing the prebaked portion of non-grain flour, the fermentation starter and the mixture of dry ingredients in a manner so as to produce the intermediary baked goods product having a consistency of a homogeneous bread-dough-like substance rather than the consistency of a batter.

According to further features the mixing of the prebaked portion of non-grain flour, the fermentation starter and the mixture of dry ingredients is effected by mixing at an initial high speed for a duration of about 1-2 minutes and thereafter at a low speed.

According to further features the mixing of the prebaked portion of non-grain flour, the fermentation starter and the mixture of dry ingredients is effected by initially mixing the prebaked portion of non-grain flour, the fermentation starter and the grain-flour portion and thereafter mixing in the binding agent.

According to still further features the binding agent is prebaked.

### DESCRIPTION OF THE PREFERRED EMBODIMENTS

Many bakery goods recipes exist which include various seeds and/or nuts in different quantities. Usually, the percentage of the seed or nut content is much lower than the percentage of grain flour in the product. Seeds/nuts or non-grain flour may be added to regular dough, but do not form the dough. The current innovation is a product and method for producing an intermediary baked goods product, such as a dough, which can be further used for the production of baked goods such as bread, pittah bread, pretzels, pizza base, flat bread, noodles, pasta and so on. The dough consists of a minor portion of grain flour such as wheat flour. The dough further consists of a primary portion of non-grain flour, such as flaxseed flour (or almond flour, soy flour etc.), with the portion of flaxseed flour being at least double the portion of wheat flour by net weight. The dough is primarily based on the non-grain ingredient. A ‘non-grain flour’ is a substance which results from grinding, grounding, crushing, or otherwise pulverizing seeds, beans (legumes), nuts and the like, but not grains. In some embodiments, the percentage of flaxseed content by net weight is at least two, three or four times greater than the portion of wheat flour by net weight. To date, compositions of baked goods with similar ratios of flaxseed to grain flour have been unable to yield a stable dough, which has the consistency of regular bread dough, but rather results in a batter that can be baked into a cake, pudding or cake-like preparation. A distinctive characteristic of dough is that dough rises as opposed to a batter which does not generally rise on its own. A further distinction relates to the viscosity of dough which is greater than that of a batter. In the art, bakers and food technicians distinguish bread from cake by describing bread as having “a crust and a crumb”. The ‘crust’ obviously refers to the crust of the bread and the crumb (not to be confused with crumbs that result from slicing bread) refers to the foam section of the bread. Even if a cake has a crust, such as with a yeast cake, the terminology ‘crust and crumb’ is not used to describe the different sections of the cake. In order to bind the aforementioned ingredients, it is necessary to include a binding agent such as gluten. Although wheat flour has been mentioned specifically, any grain flour, such as, but not limited to, rye, barley, spelt, oats or even maize, is included in the definition.

In one preferred embodiment of the invention, a fermentation starter is prepared approximately twelve hours before the dough is prepared. Preferably, if not using a starter, the fermenting agent should be natural as opposed to using a chemically induced process such as adding baking flour or mixing an acidic ingredient such as buttermilk with baking soda to produce gas in the dough. The fermentation starter of the preferred embodiment consists of yeast, room temperature water and grain flour such as wheat flour. The ingredients are mixed together and stored in a closed container for 12 hours, but the starter must been kneaded every few hours. For best results, the flaxseed flour must be baked before mixed with the other ingredients. Golden flaxseed flour is baked until attaining a brownish hue and immediately removed from the oven thereafter. Likewise, the gluten can be pre-baked. When the starter is ready, the dry ingredients of salt, gluten and flaxseed flour are mixed together and then added to the fermentation starter in a mixing bowl. A food mixer must immediately be started and run on a high speed. The minimum speed necessary for mixing dough ingredients is at least about 75 RPM and preferably between 80 RPM and 120 RPM. For the purposes of this disclosure, ‘high speed’ refers to at least 75 RPM. The approximate speed advised for kneading dough is between 30 and 50 RPM. Therefore, for the purposes of this disclosure, the term. ‘low speed’ refers to between 30 and 50 RPM. In order for the gluten to be properly mixed into the mixture, the mixer must be run at high speed for approximately 1 to 2 minutes and thereafter at a low speed for another approximately 15 minutes, until the desired bread-dough-like consistency is achieved. Alternatively, the dry ingredients excluding the gluten can be initially mixed with the fermentation starter and only when the fermentation starter has been absorbed into the mixture should the gluten be added. Adding gluten to wet ingredients (e.g. the fermentation starter) before the wet ingredients are mixed with the dry ingredients causes the gluten to achieve a chewing-gum-like consistency which cannot be efficiently used in the production process. The resulting dough then undergoes proofing, where the dough is left to rise for a portion of time in an appropriate environment as are well known in the art. The dough, when ready, can be used to prepare baked products such as bread, pittah bread, flat bread, pizza base, pretzels, baguettes, pasta, noodles and so on. The resulting baked products have a significantly lower carbohydrate count than the same baked product from grain flour dough. The product is preferably sugar free and made only from natural ingredients. Using an appropriate fermentation starter, adding a minimal yet sufficient amount of grain flour and gluten and pre-baking the non-grain flour prior to mixing the ingredients results in a dough, whereas other compositions of the same ratio of grain flour to non-grain flour have merely resulted in a batter.

### EXAMPLE 1

### Recipe for Baked Bread

Ingedients: 2 pounds of flaxseed flour from golden flaxseed. Potentially the flour can be at least 65% flaxseed.

2 pounds of gluten.

Half a pound of grain flour such as wheat flour.

2 teaspoons of natural yeast.

2 teaspoons of salt.

2 pounds room temperature water.

The ingredients are prepared and combined into a dough in the manner described above and then baked. The resulting bread has the following nutritional value: Serving size: 2 slices=56 g; Number of servings=8. Amount per serving: Total fat=7 g including 1 g of saturated fat and 0 g of trans fat. Cholesterol=0 mg; Sodium=260 mg; Total carbohydrates=9 g of which 7 g are dietary fibers and 0 g are sugars; Protein=18 g of which 4% is Calcium and 10% is Iron. The total number is Calories=170, of which the number of calories from fat=60 (according to the standard conversion table of calories per gram, whereby: 1 gram of Fat=9 calories, 1 gram of Carbohydrate=4 calories and 1 gram of Protein=4 calories).

The nutritional contents of the innovative baked goods products can significantly improve the lifestyle of diabetic and obese individuals. Diabetics will once again be able to eat bread and possibly even pizza. Individuals who are trying to lose weight can use the innovative bread as a staple food, and need not be hungry or feel unsatisfied due to the restrictions of a diet. This is not to mention the positive characteristics of flaxseed, some of which have been mentioned previously.

For example, the bread baked from the innovative dough has the same form and texture as regular bread or whole wheat bread. The food stuff is filling in a manner substantially parallel to regular bread while at the same time the amount of carbohydrates is 9 g per serving (i.e. 4.5 grams per slice!), of which 7 g are dietary fibers and 0 g sugars. For the sake of comparison: regular wheat bread, has a carbohydrate count of 26 g per the same 56 g serving (of which 4 g are sugars and only 2 g are dietary fibers).

Another possible composition of the innovative dough is derived through a substantially similar recipe, where the flaxseed content is substituted with almonds.

Yet another possible composition of the innovative dough can be derived through a substantially similar recipe, where the flaxseed content is substituted with soya bean.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An intermediary baked goods product, comprising:
(a) a portion of grain flour;
(b) a portion of non-grain flour, wherein said non-grain flour portion is at least double said portion of grain flour by net weight; and
(c) a binding agent;
the intermediary baked goods product having a consistency of a homogeneous bread dough.

2. The intermediary product of claim 1, wherein said non-grain flour is a flaxseed flour.

3. The intermediary product of claim 1, wherein said non-grain flour is a soybean flour.

4. The intermediary product of claim 1, wherein said non-grain flour is an almond flour.

5. The intermediary product of claim 1, wherein said portion of grain flour is between about 4% and about 8% of the product by net weight.

6. The intermediary product of claim 1, wherein said portion of grain flour is between about 8% and about 12% of the product by net weight.

7. The intermediary product of claim 1, wherein said portion of grain flour is between about 10% and about 18% of the product by net weight.

8. The intermediary product of claim 5, wherein said portion of non-grain flour is between about 8% and about 35% of the product by net weight.

9. The intermediary product of claim 6, wherein said portion of non-grain flour is between about 16% and about 35% of the product by net weight.

10. The intermediary product of claim 7, wherein said portion of non-grain flour is between about 20% and about 36% of the product by net weight.

11. The intermediary product of claim 1, wherein the intermediary product is sugar free.

12. The intermediary product of claim 1, wherein the intermediary product includes only natural ingredients.

13. The intermediary product of claim 1, wherein said binding agent is gluten.

14. The intermediary product of claim 1, wherein said binding agent is prebaked.

15. A final baked goods product, baked from an intermediary baked goods product, comprising:
(a) a portion of grain flour;
(b) a portion of non-grain flour, wherein said non-grain flour portion is at least double said portion of grain flour by net weight; and
(c) a binding agent;
the intermediary baked goods product having a consistency of a homogeneous bread dough.

16. The final baked goods product of claim 1′5, wherein the final baked goods product is selected from the group consisting of bread, pita bread, bagel, baguette, pizza base, flat bread, pasta and noodles.

17. A method for preparing an intermediary baked goods product, the method comprising the steps of:
(a) providing a prebaked portion of non-grain flour;
(b) providing a fermentation starter;
(c) providing a mixture of dry ingredients including a portion of grain flour and a binding agent, wherein said non-grain flour portion is at least double said portion of grain flour by net weight; and
(d) mixing said prebaked portion of non-grain flour, said fermentation starter and said mixture of dry ingredients in a manner so as to produce the intermediary baked goods product having a consistency of a homogeneous bread dough.

18. The method of claim 17, wherein said mixing of said prebaked portion of non-grain flour, said fermentation starter and said mixture of dry ingredients is effected by mixing at an initial high speed for a duration of about 1-2 minutes and thereafter at a low speed.

19. The method of claim 17, wherein said mixing of said prebaked portion of non-grain flour, said fermentation starter and said mixture of dry ingredients is effected by initially mixing said prebaked portion of non-grain flour, said fermentation starter and said grain-flour portion and thereafter mixing in said binding agent.

20. The method of claim 17, wherein said binding agent is prebaked.
